(19) United States
(12) Patent Application Publication
(10) Pub. No.: US 2020/0254522 A1
(43) Pub. Date: Aug. 13, 2020

(54) OMNIDIRECTIONAL RECOATER

(71) Applicant: General Electric Company, Schenectady, NY (US)

(72) Inventors: MacKenzie Ryan Redding, Mason, OH (US); Justin Mamrak, Loveland, OH (US)

(21) Appl. No.: 16/761,722

(22) PCT Filed: Nov. 2, 2018
(86) PCT No.: PCT/US2018/058891

§ 371 Date: May 5, 2020

Related U.S. Application Data
(60) Provisional application No. 62/583,383, filed on Nov. 8, 2017.

(51) Int. Cl. B22F 3/105; B33Y 10/00; B33Y 30/00

(52) U.S. Cl. CPC B22F 3/1055; B22F 2003/1056; B33Y 30/00; B33Y 10/00

(57) ABSTRACT

The present disclosure generally relates to methods and apparatuses (200) for additive manufacturing with improved powder (702) distribution capabilities. One aspect involves a mobile build unit (700) that can be moved around in two to three dimensions by a positioning system, to build separate portions of an object, such as a large object. The mobile build unit (700) may be used with an energy directing device (712) that directs irradiation onto a powder (702) layer. In the case of laser irradiation, the mobile build unit (700) may be used with a gasflow device (713A, 713B) that provides laminar gas flow to a laminar flow zone (714) above the layer of powder (703). The mobile build unit (700) of the present disclosure also has a recoater (705) concentrically surrounding a mobile build area, the re-coater (705) allowing the mobile build unit (700) to selectively deposit particular quantities of powder (702) in specific locations over a work surface in order to build large, high quality, high precision objects.

### PRIORITY INFORMATION

The present applicant claims priority to U.S. Provisional Patent Application Ser. No. 62/583,383 titled “Omnidirectional Recoater” filed on Nov. 8, 2017, the disclosure of which is incorporated by reference herein.

### CROSS-REFERENCE TO RELATED APPLICATIONS

Reference is made to the following related applications, the entirety of which are incorporated herein by reference:

U.S. patent application Ser. No. 15/406,467, titled “Additive Manufacturing Using a Mobile Build Volume,” with attorney docket number 037216.00059, and filed Jan. 13, 2017.

U.S. patent application Ser. No. 15/406,454, titled “Additive Manufacturing Using a Mobile Scan Area,” with attorney docket number 037216.00060, and filed Jan. 13, 2017.

U.S. patent application Ser. No. 15/406,444, titled “Additive Manufacturing Using a Dynamically Grown Wall,” with attorney docket number 037216.00061, and filed Jan. 13, 2017.

U.S. patent application Ser. No. 15/406,461, titled “Additive Manufacturing Using a Selective Recoater,” with attorney docket number 037216.00062, and filed Jan. 13, 2017.

U.S. patent application Ser. No. 15/406,471, titled “Large Scale Additive Machine,” with attorney docket number 037216.00071, and filed Jan. 13, 2017.

### FIELD

The present disclosure generally relates to improved methods and apparatuses for additive manufacturing. More specifically, the present disclosure is directed to mobile build units with novel geometries.

### BACKGROUND

Additive manufacturing (AM) or additive printing processes generally involve the buildup of one or more materials to make a net or near net shape (NNS) object, in contrast to subtractive manufacturing methods. Though “additive manufacturing” is an industry standard term (ISO/ASTM52900), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses electromagnetic radiation such as a laser beam, to melt or sinter a powdered material, creating a solid three-dimensional object.

Conventional apparatuses for AM often use a recoater mechanism 100 such as that shown in FIGS. 1A-1B. The recoater mechanism 100, such as recoater blade 101, is moved in direction 104 to spread deposited powder 102 into a powder layer 103 in a build area defined by the powder layer 103. FIG. 1A shows a side view and FIG. 1B shows a top view; in FIGS. 1A-1B, recoater blade 101 moves in the x-direction (or direction 104) and spreads deposited powder 102 into powder layer 103 in the xy-plane. Deposited powder 102 may be in piles, mounds, or lumps, and recoater blade 101 may act to smooth it out by spreading it into powder layer 103. In conventional apparatuses, a straight recoater blade 101 provides a single edge to spread deposited powder 102 in front of one face of the blade 101 into a powder layer 103 on the other face.

### BRIEF DESCRIPTION

Aspects and advantages will be set forth in part in the following description, or may be obvious from the description, or may be learned through practice of the invention.

In one aspect, the present disclosure is directed to an apparatus for making an object from powder, the apparatus comprising: a mobile build unit comprising: a recoater blade, the recoater blade concentrically surrounding a mobile build area having a first work surface; a positioning system adapted to provide independent movement of the build unit in at least two dimensions that are substantially parallel to the first work surface; and a powder dispenser, the powder dispenser positioned radially outward from the recoater blade. In some aspects, the powder dispenser comprises a powder storage area and at least a first gate, the first gate operable by a first actuator that allows opening and closing of the first gate, the first gate adapted to control the dispensation of powder from the powder storage area onto a second work surface, the second work surface positioned radially outward from the recoater blade. In some aspects, the first actuator is electric or pneumatic. In some aspects, the powder dispenser concentrically surrounds the gasflow device. In some aspects, the powder dispenser comprises a plurality of gates, wherein each of the plurality of gates is independently operable by a respective actuator. In some aspects, the powder dispenser is configured to revolve concentrically around the recoater blade. In some aspects, the positioning system is adapted to provide independent movement of the mobile build unit in two dimensions that are substantially parallel to the first work surface and in a third dimension that is substantially normal to the first work surface. In some aspects, the first gate is attached to a spring mounted to the powder dispenser that opposes the force of the actuator. In some aspects, the apparatus further comprises an irradiation emission directing device, wherein the irradiation emission directing device during operation of the apparatus directs an energy beam to pass through the mobile build area. In some aspects, the mobile build unit further comprises a gasflow device with a laminar flow zone, the gasflow device adapted to provide substantially laminar gas flow within two inches of, and substantially parallel to, the first work surface, and wherein the recoater blade concentrically surrounds the recoater blade. In some aspects, the apparatus further comprises an irradiation emission directing device, wherein the irradiation emission directing device during operation of the apparatus directs an energy beam to pass through the laminar flow zone.

In another aspect, the present disclosure is directed to a method of making an object from powder, the method comprising: (a) moving an apparatus comprising a mobile build unit to deposit a first layer of powder over at least a first portion of a first work surface, the mobile build unit comprising: a recoater blade, the recoater blade concentrically surrounding a mobile build area having the first work surface; a positioning system adapted to provide independent movement of the build unit in at least two dimensions that are substantially parallel to the first work surface; and a powder dispenser, the powder dispenser positioned radially outward from the recoater blade; (b) irradiating at least part of the first layer of powder within the mobile build area to form a fused layer, wherein irradiating comprises an irradiation emission directing device directing an energy beam to irradiate the at least part of the first layer of powder within the mobile build area to form a fused layer; and (c) repeating at least steps (a) through (b) to form the object. In some aspects, the powder dispenser comprises a powder storage area and at least a first gate, the first gate operable by a first actuator that allows opening and closing the first gate, the first gate adapted to control the dispensation of powder from the powder storage area onto a second work surface, the second work surface positioned radially outward from the recoater blade. In some aspects, the first actuator is electric or pneumatic. In some aspects, the powder dispenser concentrically surrounds the recoater blade, and the powder dispenser comprises a plurality of gates, wherein each of the plurality of gates is independently operable by a respective actuator. In some aspects, each of the plurality of gates on a leading edge of the recoater arm is open and each of the plurality of gates on a trailing edge of the recoater arm is closed. In some aspects, the powder dispenser is configured to revolve concentrically around the recoater blade. In some aspects, the positioning system is adapted to provide independent movement of the build unit in two dimensions that are substantially parallel to the first work surface and in a third dimension that is substantially normal to the first work surface. In some aspects, the first gate is attached to a spring mounted to the powder dispenser that opposes the force of the actuator. In some aspects, the apparatus further comprises an irradiation emission directing device, wherein the irradiation emission directing device during operation of the apparatus directs an energy beam to pass through the mobile build area. In some aspects, the mobile build unit further comprises a gasflow device with a laminar flow zone, the gasflow device adapted to provide substantially laminar gas flow within two inches of, and substantially parallel to, the first work surface, and wherein the recoater blade concentrically surrounds the gasflow device. In some aspects, the apparatus further comprises an irradiation emission directing device, wherein the irradiation emission directing device during operation of the apparatus directs an energy beam to pass through the laminar flow zone.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1A shows a side schematic view of a recoater moving to spread a powder over a build area according to conventional methods.

FIG. 1B shows a top schematic view of a recoater moving to spread a powder over a build area according to conventional methods.

FIG. 2 shows a top schematic view of a mobile build unit moving in a direction to spread a powder over a build area according to some aspects of the present disclosure.

FIG. 3 shows a top schematic view of a mobile build unit moving in an alternate direction to spread a powder over a build area according to some aspects of the present disclosure.

FIG. 4 shows a top schematic view of a recoater blade and a powder dispenser according to some aspects of the present disclosure.

FIG. 5 shows a top schematic view of moving the recoater blade and powder dispenser of FIG. 4.

FIG. 6 shows a top schematic view of a recoater blade and a powder dispenser according to other aspects of the present disclosure.

FIG. 7 shows a cross-sectional view of an example of an apparatus for making an object from powder according to some aspects of the present disclosure.

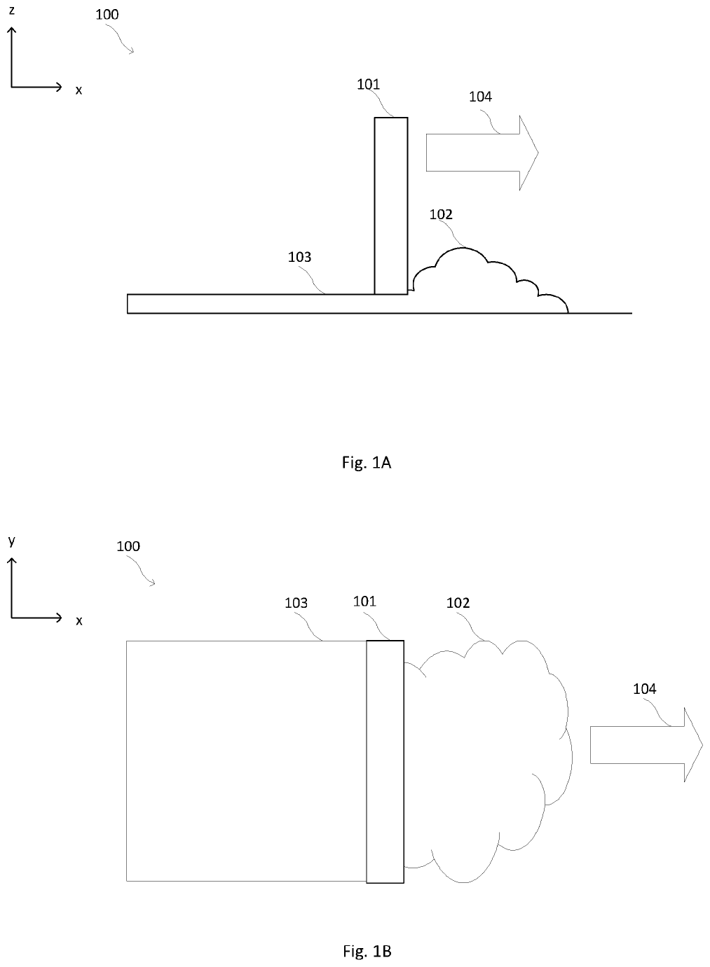

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present application is directed to an apparatus that can be used to perform AM, as well as methods for utilizing the apparatus to additively manufacture objects. All aspects and embodiments described with respect to the apparatus apply to the methods with equal force, and vice versa.

The apparatus includes components that make it particularly useful for making large additively manufactured objects. Apparatuses of the present disclosure may be used in layer-wise methods for AM of objects, such as those described in U.S. patent application Ser. Nos. 15/406,467, 15/406,454, 15/406,444, 15/406,461, 15/406,470, all filed Jan. 13, 2017 and all hereby incorporated by reference herein. In such methods, a first layer of powder is provided in a build area, the layer is irradiated using an energy source (such as a laser source or an electron beam (e-beam) source) to form a fused layer, a new layer of powder is provided, the new layer is irradiated to be fused, and so on. One aspect of the present invention is a mobile build unit. The build unit may be configured to include several components necessary for making high precision, large scale additively manufactured objects. These components may include, for example, a recoater, such as a recoater blade, a positioning system, and a powder dispenser. In some embodiments, the components may also include one or more of a gasflow device with a gasflow zone, and an irradiation emission directing device. In some embodiments, the apparatus comprises a mobile build unit comprising one or more of the components. In some embodiments, the mobile build unit comprises a recoater and a powder dispenser, and one or more of a positioning system, a gasflow device, and an irradiation emission directing device may be included in the apparatus as a whole but not in the mobile build unit. In some embodiments, the apparatus comprises a mobile build unit comprising a recoater, a powder dispenser, and a positioning system. In some embodiments, the mobile unit further comprises an irradiation emission directing device. In some embodiments, the mobile unit further comprises a gasflow device.

An irradiation emission directing device used in an embodiment of the present invention may be, for example, an optical control unit for directing a laser beam. An optical control unit may comprise, for example, optical lenses, deflectors, mirrors, and/or beam splitters. Advantageously, a telecentric lens may be used. Alternatively, the irradiation emission directing device may be an electronic control unit for directing an e-beam. The electronic unit may be comprise, for example, deflector coils, focusing coils, or similar elements. In embodiments including an irradiation emission directing device, irradiation may comprise an irradiation emission directing device directing an energy beam to irradiate at least part of a first layer of powder within a mobile build area to form a fused layer. The build unit may be attached to a positioning system (e.g., a gantry, delta robot, cable robot, robot arm, belt drive, etc.) that allows two- to three-dimensional movement throughout a build environment.

The apparatus and methods of the present disclosure may be used with any metal powder build material such as those known to persons of ordinary skill in the art. Suitable metal powders include, but are not limited to, cobalt chrome, stainless steels, tooling steel, maraging steel, aluminum alloys, titanium alloys, nickel alloys, and copper alloys.

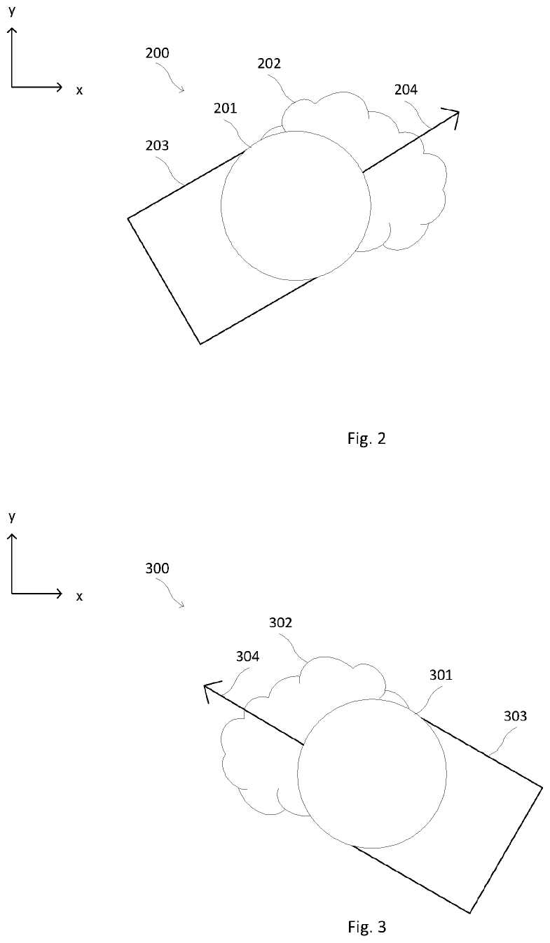

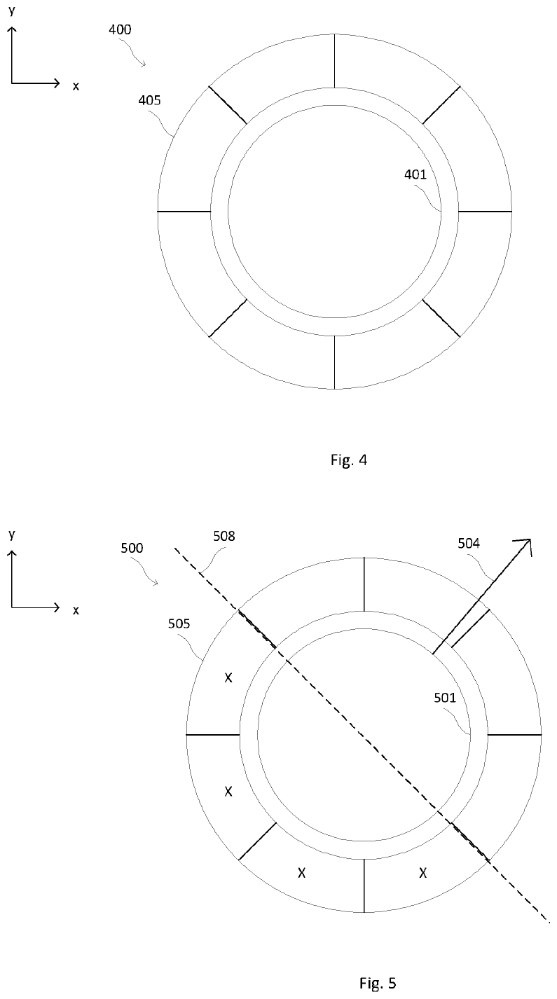

FIG. 2 shows a schematic view of an AM apparatus 200 according to some aspects of the present disclosure. Recoater blade 201 concentrically surrounds a mobile build area (not shown) and moves in direction 204 in the xy-plane to spread deposited powder 202 into powder layer 203. FIG. 3 shows an alternate schematic view. Specifically, FIG. 3 shows a schematic view of an AM apparatus 300 including a recoater blade 301 that concentrically surrounds a mobile build area and moves in direction 304 in the xy-plane to spread deposited powder 302 into powder layer 303. Direction 204 or 304 may be any vectorial direction in the xy-plane.

Although the recoater blade 201 is depicted as a circle in the accompanying drawings, it is to be understood that the recoater blade 201 is not limited to being circular in shape and can be any concentric or non-concentric arrangement surrounding the build area. The recoater blade may be any shape, including, but not limited to, triangular, rectangular, ovular, square, polygonal, racetrack-shaped, or the like, and is not limited to being continuous in nature. The recoater blade may be symmetric or asymmetric in the xy-plane, i.e., the recoater blade may or may not have a plane of symmetry in the xz-plane and/or the yz-plane.

As used herein, the “mobile build area” is defined as the volume concentrically surrounded by the recoater blade. The mobile build area contains a first work surface upon which deposited powder 202 is spread to provide powder layer 203. For building the initial or first layer of the object, the first work surface may be a sacrificial or other surface that does not end up in the finished object. For building successive layers of the object, including the final layer of the object, the first work surface may be the uppermost surface of the object in progress, i.e., the most recently completed layer.

In some aspects the positioning system is adapted to provide independent movement of the build unit in at least two dimensions substantially parallel to the first work surface. In other aspects, the positioning system is adapted to provide independent movement of the build unit in two dimensions that are substantially parallel to the first work surface and a third dimension that is substantially normal to the first work surface.

In some aspects, the apparatus 200 further comprises an irradiation emission directing device, wherein the irradiation emission directing device during operation of the apparatus directs an energy beam to pass through the mobile build area. In so doing, the energy beam may irradiate at least a portion of the powder layer 203, thereby melting, sintering, and/or fusing the powder layer 203.

FIG. 4 shows an apparatus 400 according to some aspects of the present disclosure. Recoater blade 401 may be similar in some aspects to recoater blade 201. In some aspects, a powder dispenser 405 is positioned radially outward from recoater blade 401. In some aspects, powder dispenser 405 comprises a powder storage area and at least a first gate, the first gate operable by a first actuator that allows opening and closing the first gate, the first gate adapted to control the dispensation of powder from the powder storage area onto a second work surface, the second work surface positioned radially outward from the recoater blade. In some aspects, actuators may be electric or pneumatic. The first gate may be operable by the actuator by any suitable means. For example, the first gate is attached to a spring mounted to the powder dispenser that opposes the force of the actuator. In some aspects, powder dispenser 405 may comprise a plurality of gates; in the aspect depicted in FIG. 4, powder dispenser 405 contains 8 gates, but it is to be understood that the powder dispenser may comprise any number of gates, and that the gates may be of equal or different sizes. In such aspects, each of the plurality of gates may be independently operable by a respective actuator. In some such aspects, the plurality of gates concentrically surrounds the recoater blade.

The apparatus 500 (FIG. 5) is an example of an apparatus according to such aspects; apparatus 500 may be similar in some aspects to apparatus 400. In the aspect depicted in FIG. 5, latitudinal axis 508 divides recoater blade 501 in half, into a leading edge and a trailing edge relative to direction 504 of motion. Latitudinal axis 508 may be a physical axis, such as a physical pole protruding from two points on recoater blade 501 spaced 180 degrees apart, or latitudinal axis 508 may be an imaginary line. In some such aspects, the four gates of powder dispenser 505 along the leading edge are open and the four gates of dispenser 505 along the trailing edge are closed. As used herein, “open” gates permit the dispensation, depositing, or flow of powder out of the respective gate and onto the second work surface; and “closed” gates do not, retaining the powder in the powder storage area. The gates and/or the recoater blade may be made of the same material as the powder or a material compatible with the powder, e.g., to prevent contamination and/or undesired side reactions of the powder with the apparatus materials.

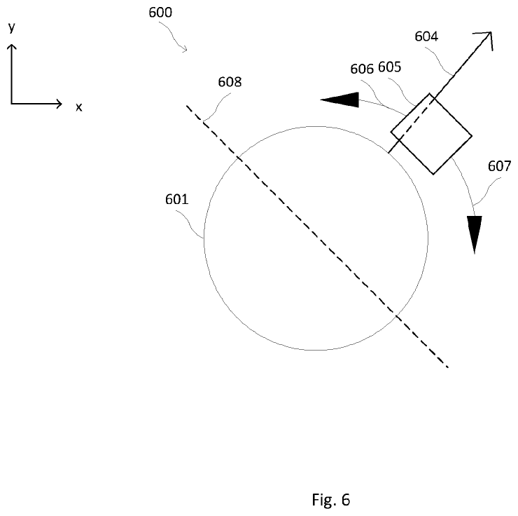

In other aspects, such as that depicted in FIG. 6, apparatus 600 may comprise a powder dispenser 605 with one or more gates, but not concentrically surrounding recoater blade 601 at all times. Rather, powder dispenser 605 may be positioned radially outward of recoater blade 601 but opposite only a portion of the circumference or perimeter of recoater blade 601 at a time. In such aspects, powder dispenser 605 may be configured to revolve concentrically around recoater blade 601. In some aspects, powder dispenser 605 may be configured to revolve around the entire circumference or perimeter of recoater blade 601. In other aspects, latitudinal axis 608 (dividing recoater blade 601 into a leading edge and a trailing edge relative to direction 604 of motion) may limit the revolution of powder dispenser 605 around recoater blade 601 in directions 606, 607. Latitudinal axis 608 may be similar in some aspects to latitudinal axis 508.

In some aspects, the apparatus or the mobile build unit may further comprise a gasflow device with a laminar flow zone, the gasflow device adapted to provide substantially laminar gas flow substantially parallel to the first work surface, and wherein the recoater blade concentrically surrounds the gasflow device. In this regard, it should be appreciated that the gas flow need not be perfectly laminar according to certain embodiments. Suitable gasflow devices include those described in U.S. patent application Ser. Nos. 15/406,467, 15/406,454, 15/406,444, 15/406,461, 15/406,470, all filed Jan. 13, 2017 and all hereby incorporated by reference herein. In some aspects, the gasflow device may occupy at least a portion of the mobile build area and be positioned vertically above the first work surface. As used herein, when a first object is “above” or “vertically above” a second object, the first object is spaced in the positive z-direction relative to the second object.

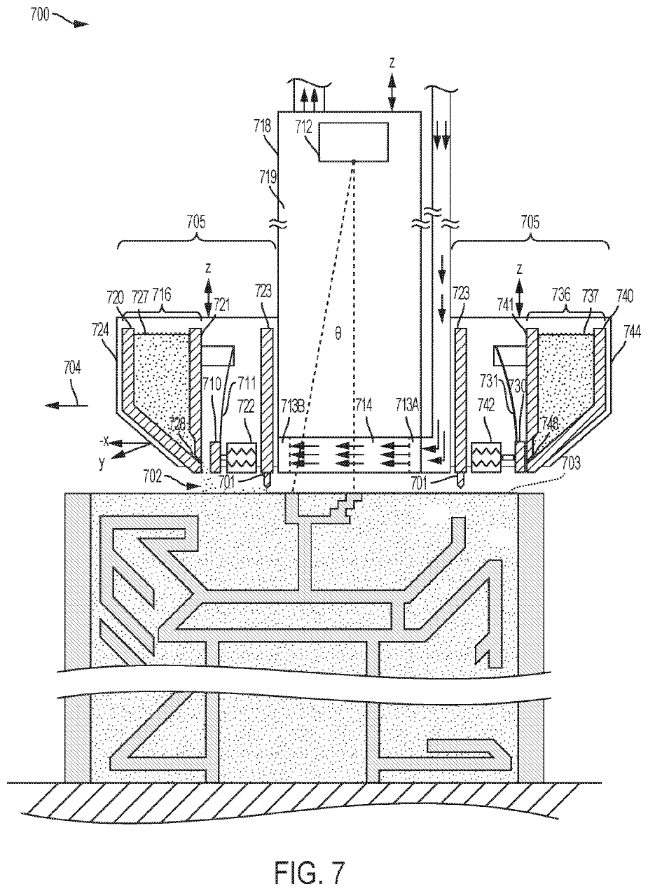

FIG. 7 shows a longitudinal cross-sectional view of an example of a mobile build unit 700 comprising an irradiation emission directing device 712, a gasflow device 713 with a pressurized outlet portion 713A and a vacuum inlet portion 713B providing gas flow to a gasflow zone 714, and a powder dispenser 705. Mobile build unit 700 may be similar in some aspects to apparatus 200. Above the gasflow zone 714 there is an enclosure 718 containing an inert environment 719. The powder dispenser 705 has a hopper 716 comprising a back plate 720 and a front plate 721. The powder dispenser 705 also has at least one actuating element 711, at least one gate plate 710, a recoater blade 701, an actuator 722, and a recoater arm 723. The recoater is mounted to a mounting plate 724. FIG. 7 also shows a build envelope that may be built by, for example, additive manufacturing or Mig/Tig welding, an object being formed, and powder 727 contained in the hopper 705 used to form the object. In this particular embodiment, the actuator 722 activates the actuating element 711 to pull the gate plate 710 away from the front plate 721. In an embodiment, the actuator 722 may be, for example, a pneumatic actuator, and the actuating element 711 may be a bidirectional valve. In an embodiment, the actuator 722 may be, for example, a voce coil, and the actuating element 711 may be a spring. There is also a hopper gap 728 between the front plate 721 and the back plate 720 that allows powder to flow when a corresponding gate plate is pulled away from the powder gate (or the gate is opened) by an actuating element. The powder 727, the back plate 720, the front plate 721, and the gate plate 710 may all be the same material. Alternatively, the back plate 720, the front plate 721, and the gate plate 710 may all be the same material, and that material may be one that is compatible with the powder material, such as cobalt chrome. In this particular illustration of one embodiment of the present invention, the gas flow in the gasflow zone 714 flows in the y-direction, but it does not have to. That is, the gas flow in gasflow zone 714 may flow in the x-direction or in any direction in the xy-plane. The recoater blade 701 has a width in the x-direction in the cross-sectional view depicted. The direction of the irradiation emission beam when θ is approximately zero defines the z-direction in this view. The gas flow in the gasflow zone 714 may be substantially laminar. The irradiation emission directing device 712 may be independently movable by a second positioning system (not shown) this illustration shows the gate plate 710 in the open position and gate plate 730 in the closed position. Powder in the hopper 705 is deposited to make fresh deposited powder 702, which is smoothed over by the recoater blade 701 to make a substantially even powder layer 703. In some embodiments of the present application, the substantially even powder layer 703 may be irradiated at the same time that the build unit is moving, which would allow for continuous operation of the build unit and thus faster production of the object.

In the view depicted in FIG. 7, mobile build unit 700 comprises at least two gates as indicated by gate plates 710, 730. Gate plate 730 may be similar in some aspects to gate plate 710. Actuating element 731 may be similar in some aspects to actuating element 711. Powder 737 may be similar in some aspects to powder 727. Front plate 741 may be similar in some aspects to front plate 721. Back plate 740 may be similar in some aspects to back plate 720. Hopper 736 may be similar in some aspects to hopper 716. Mounting plate 744 may be similar in some aspects to mounting plate 724. Hopper gap 748 may be similar in some aspects to hopper gap 728. Actuator 742 may be similar in some aspects to actuator 722.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

Moreover, all references throughout this application, for example patent documents including issued or granted patents or equivalents; patent application publications; and non-patent literature documents or other source material; are hereby incorporated by reference herein in their entireties, as though individually incorporated by reference.

What is claimed is:

1. An apparatus (200) for making an object from powder (702), the apparatus (200) comprising:
a mobile build unit (700) comprising:
a recoater blade (701), the recoater blade (701) surrounding a mobile build area having a first work surface;
a positioning system adapted to provide independent movement of the mobile build unit (700) in at least two dimensions that are substantially parallel to the first work surface; and
a powder dispenser (405), the powder dispenser (405) positioned radially outward from the recoater blade (701).

2. The apparatus (200) of claim 1, the powder dispenser (405) comprising a powder storage area and at least a first gate (710), the first gate (710) operable by a first actuator (722) that allows opening and closing the first gate (710), the first gate (710) adapted to control the dispensation of powder (702) from the powder storage area onto a second work surface, the second work surface positioned radially outward from the recoater blade (701).

3. The apparatus (200) of claim 2, wherein the first actuator (722) is electric or pneumatic.

4. The apparatus (200) of claim 2, wherein the powder dispenser (405) surrounds the recoater blade (701).

5. The apparatus (200) of claim 4, wherein the powder dispenser (405) comprises a plurality of gates (710, 730), wherein each of the plurality of gates (710, 730) is independently operable by a respective actuator (722, 742).

6. The apparatus (200) of claim 1, wherein the powder dispenser (405) is configured to revolve concentrically around the recoater blade (701).

7. The apparatus (200) of claim 1, wherein the positioning system is adapted to provide independent movement of the mobile build unit (700) in two dimensions that are substantially parallel to the first work surface and in a third dimension that is substantially normal to the first work surface.

8. The apparatus (200) of claim 2, wherein the first gate (710) is attached to a spring mounted to the powder dispenser (405) that opposes the force of the actuator.

9. The apparatus (200) of claim 1, further comprising an irradiation emission directing device (712), wherein the irradiation emission directing device (712) during operation of the apparatus (200) directs an energy beam to pass through the mobile build area.

10. The apparatus (200) of claim 1, wherein the mobile build unit (700) further comprises a gasflow device (713A, 713B) with a substantially laminar flow zone (714), the gasflow device (713A, 713B) adapted to provide substantially laminar gas flow within two inches of, and substantially parallel to, the first work surface, and wherein the recoater blade (701) concentrically surrounds the gasflow device (713A, 713B).

11. The apparatus (200) of claim 10, further comprising an irradiation emission directing device (712), wherein the irradiation emission directing device (712) during operation of the apparatus (200) directs an energy beam to pass through the laminar flow zone (714).

12. A method of making an object from powder (702), the method comprising:
(a) moving an apparatus (200) comprising a mobile build unit (700) to deposit a first layer of powder (702) over at least a first portion of a first work surface, the mobile build unit (700) comprising:
a recoater blade (701), the recoater blade (701) concentrically surrounding a mobile build area having the first work surface;
a positioning system adapted to provide independent movement of the mobile build unit (700) in at least two dimensions that are substantially parallel to the first work surface; and
a powder dispenser (405), the powder dispenser (405) positioned radially outward from the recoater blade (701);
(b) irradiating at least part of the first layer of powder (702) within the mobile build area to form a fused layer, wherein irradiating comprises an irradiation emission directing device (712) directing an energy beam to irradiate the at least part of the first layer of powder (702) within the mobile build area to form a fused layer; and
(c) repeating at least steps (a) through (b) to form the object.

13. The method of claim 12, the powder dispenser (405) comprising a powder storage area and at least a first gate (710), the first gate (710) operable by a first actuator (722) that allows opening and closing the first gate (710), the first gate (710) adapted to control the dispensation of powder (702) from the powder storage area onto a second work surface, the second work surface positioned radially outward from the recoater blade (701).

14. The method of claim 13, wherein the powder dispenser (405) concentrically surrounds the recoater blade (701), and wherein the powder dispenser (405) comprises a plurality of gates (710, 730), wherein each of the plurality of gates (710, 730) is independently operable by a respective actuator (722, 742), wherein each of the plurality of gates (710, 730) on a leading edge of the recoater arm (723) is open and each of the plurality of gates (710, 730) on a trailing edge of the recoater arm (723) is closed.

15. The method of claim 12, wherein the powder dispenser (405) is configured to revolve concentrically around the recoater blade (701).
